(19) United States
(12) Patent Application Publication
(10) Pub. No.: US 2022/0071431 A1
(43) Pub. Date: Mar. 10, 2022

(54) Juicer with Crank

(71) Applicant: Progressive International Corporation, Kent, WA (US)

(72) Inventors: Joseph Kent, Seattle, WA (US); Sascha Kaposi, Tacoma, WA (US); Geoff Woo, Seattle, WA (US)

(73) Assignee: Progressive International Corporation, Kent, WA (US)

(21) Appl. No.: 17/468,391

(22) Filed: Sep. 7, 2021

Related U.S. Application Data
(60) Provisional application No. 63/074,573, filed on Sep. 4, 2020.

(51) Int. Cl. A47J 19/02

(52) U.S. Cl. CPC A47J 19/023

(57) ABSTRACT

A juicer includes a container, a crank, a strainer, and a reamer. The strainer includes a floor having a plurality of through-holes, and a peripheral sidewall. The container has a pair of spouts, each configured to selectively support a crank support formed in the strainer. The reamer is supported above the strainer and coupled to the crank for rotation by the crank so that juice expressed from a fruit will flow down the reamer to the strainer, with pulp being captured by the strainer while juice flows through the through-holes provided in the strainer and into the container.

### BACKGROUND OF THE INVENTION

A hand-operated juicer for squeezing juice from citrus fruits such as oranges can be a very useful tool. In some instances, a manual crank can be incorporated into the juicer, allowing a user to rotate a reamer by operation of the crank. Others have created hand-crank operable juicers of this sort, such as in U.S. Pat. No. 1,971,657 by J. P. Quam. The Quam device may have been useful in its time, but it has several defects in the operation of the crank and its associated gear, the way in which the strainer interacts with the container, and other aspects.

### SUMMARY OF THE INVENTION

A preferred version of a juicer includes a container having a bottom and an upwardly extending sidewall terminating in a rim at an upper end of the container to define an interior space. A first spout is formed on the rim and a second spout formed on the rim. A strainer is removably attached to the upper end of the container, the strainer having a plurality of through-holes and a spindle defining a central axis of the strainer, the strainer further having a crank bearing. A crank includes a crank axle, the crank axle being retained within the crank bearing and terminating in a drive gear, the drive gear being coupled to the reamer for rotation of the reamer via rotation of the crank axle. The strainer is selectively positionable in either a first position in which the crank bearing is seated in the first spout, or a second position in which the crank bearing is seated in the second spout.

In some versions, the reamer is coupled to a ring gear, the ring gear engaging the drive gear to rotate the reamer.

In some versions, a sweeper is supported by the spindle, the sweeper having one or more sweep arms extending radially outwardly from the spindle, the spindle coupled to and supporting the reamer, and the ring gear is formed on a surface of the sweeper, whereby rotation of the drive gear causes rotation of the sweeper and the reamer.

In some versions, a spindle bearing is attached to the spindle, the sweeper having a central pillar with an internal cavity which receives the spindle bearing for rotation of the central pillar about the spindle bearing.

In some versions, the first spout and the second spout are diametrically opposite each other.

In some versions, the strainer includes a boss, the boss retaining a portion of the crank axle.

In some versions, the strainer includes a lower skirt, the slower skirt extending below the upper rim when the strainer is positioned at the upper end of the container. The lower skirt may have one or more ribs on an outer surface of the skirt.

In some versions, the strainer further comprises an upper strainer sidewall.

In some versions, the juicer includes a container having a bottom and an upwardly extending sidewall terminating in a rim at an upper end of the container to define an interior space. A first spout is formed on the rim and a second spout formed on the rim. A strainer having an upwardly extending strainer sidewall and includes one or more through-holes, the strainer further having a crank bearing, the strainer being selectively supportable by the container in either a first position in which the crank bearing is seated in the first spout, or a second position in which the crank bearing is seated in the second spout. A reamer is supported by the strainer for rotation atop the strainer. A crank includes a crank axle, the crank axle being retained within the crank bearing and terminating in a drive gear, the drive gear being coupled to the reamer for rotation of the reamer via rotation of the crank axle.

In some versions, the reamer is further coupled to a ring gear, the ring gear engaging the drive gear to rotate the reamer.

In some versions, a reamer base is supported by the strainer, the reamer base coupled to and supporting the reamer, and the ring gear is formed on a surface of the reamer base, so that rotation of the drive gear causes rotation of the reamer base and the reamer.

In some versions, a spindle is poisoned on the strainer and a spindle bearing attached to the spindle, the reamer base having a central pillar with an internal cavity which receives the spindle bearing for rotation of the central pillar about the spindle bearing.

In some versions, the first spout and the second spout are diametrically opposite each other.

In some versions, the strainer further includes a boss, the boss retaining a portion of the crank axle.

In some versions, the strainer further includes a lower skirt, the slower skirt extending below the upper rim when the strainer is positioned at the upper end of the container.

In some versions, the reamer base is configured as a sweeper having one or more radially extending sweeper arms.

### BRIEF DESCRIPTION OF THE DRAWINGS

The preferred juicer is described below with reference to the following figures.

FIG. 1 is a front elevational view of a preferred juicer.

FIG. 2 is a top perspective view of the preferred juicer.

FIG. 3 is an exploded view of the preferred juicer.

FIG. 4 is a top perspective view of the preferred juicer, with a reamer removed.

FIG. 5 is a top plan view of the preferred juicer.

FIG. 6 is a top perspective view of the preferred juicer, with the reamer removed and a sweeper in place.

FIG. 7 is a top perspective view of the preferred juicer, with the reamer removed and with a spindle bearing in place.

FIG. 8 is a bottom plan view of the juicer without the container, and therefore showing the crank, strainer, and gear.

FIG. 9 is a bottom perspective view of the same components shown in FIG. 8.

FIG. 10 is an alternate bottom perspective view of the components shown in FIG. 8.

FIG. 11 is a preferred container for use with a preferred juicer.

FIG. 12 shows a top perspective view of a preferred sweeper.

FIG. 13 shows a bottom plan view of the preferred sweeper.

FIG. 14 is a bottom perspective view of the preferred drive gear, sweeper, and reamer with other components removed.

FIG. 15 is a bottom perspective view of a preferred sweeper.

FIG. 16 is a top plan view of the juicer, with the reamer and sweeper removed.

FIG. 17 is a bottom plan view of a preferred spindle bearing.

FIG. 18 is a bottom perspective view of a preferred spindle bearing.

FIG. 19 is a bottom perspective view of a preferred reamer.

### DETAILED DESCRIPTION OF THE PREFERRED EMBODIMENT

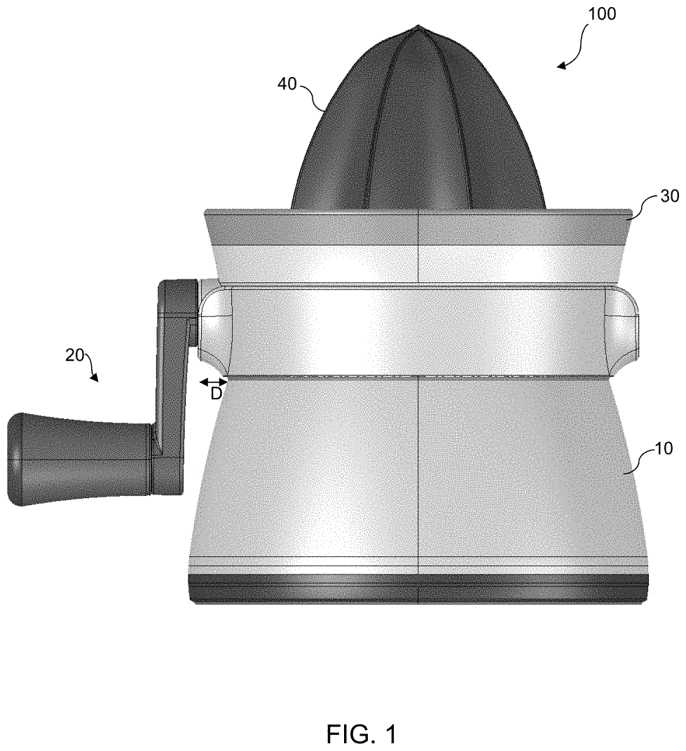

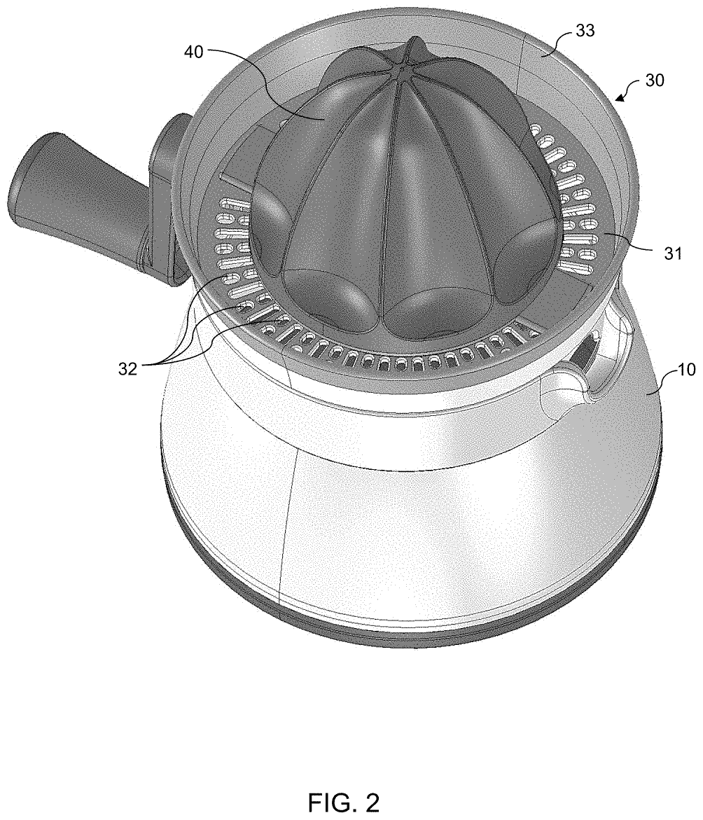

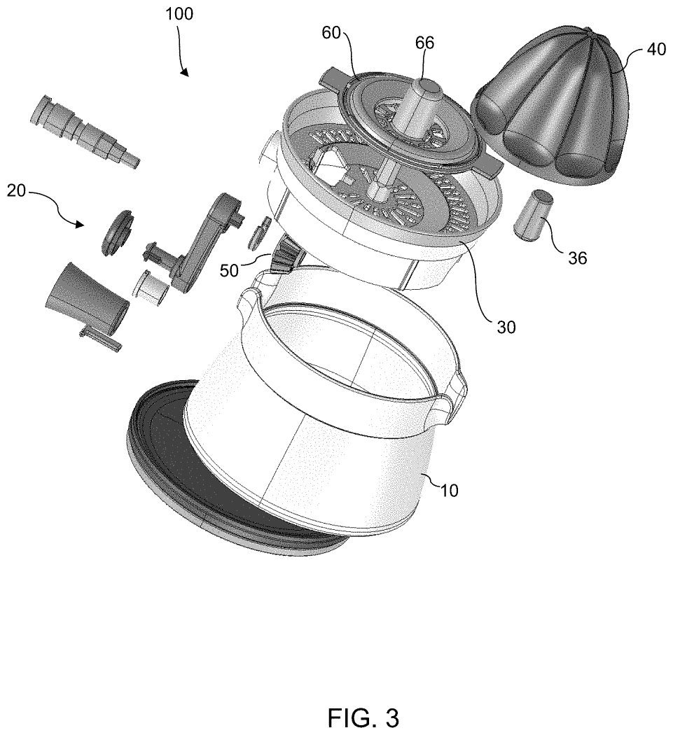

A preferred version of a juicer 100 is shown in the accompanying figures. FIG. 1 illustrates the juicer in a front elevational view, while it is shown in a top perspective view in FIG. 2 and an exploded view in FIG. 3.

In general, the juicer includes a container 10, a crank 20, a strainer 30, and a reamer 40. The strainer includes a floor 31 having a plurality of through-holes 32, and a peripheral sidewall 33. The reamer 40 is supported above the strainer so that juice expressed from the fruit will flow down the reamer to the strainer, with pulp being captured by the strainer while juice flows through the through-holes provided in the strainer and into the container 10.

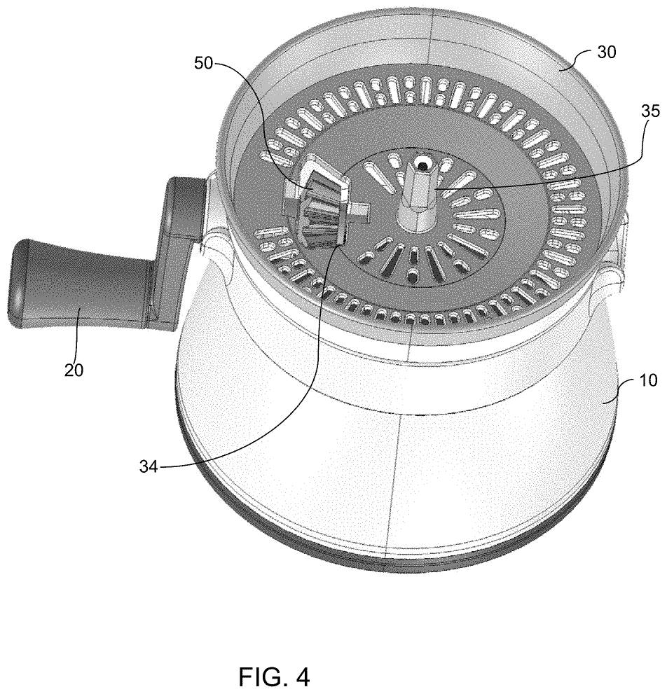

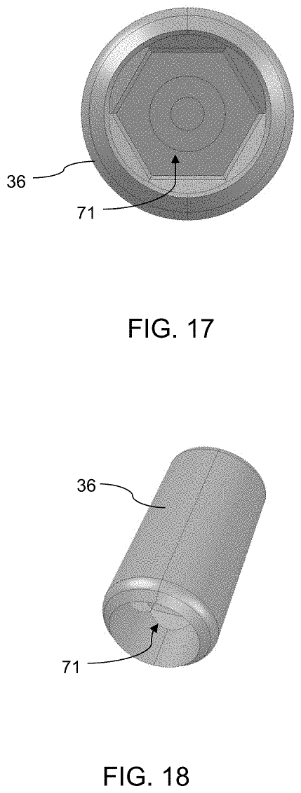

In the top perspective view of FIG. 4, the reamer has been removed to illustrate the operation of the crank. With the reamer removed, a drive gear 50 is visible through an opening 34 at one side of the strainer 30, and in the preferred example the drive gear is configured as a pinion gear and, more preferably, a bevel gear. The strainer includes a spindle 35, which is preferably integrally formed with the strainer and defines a central axis extending upwardly from the strainer, away from the lower container when the strainer is seated on the container. In the illustrated example, the spindle is formed with a hexagonal perimeter, or is otherwise splined in order to capture a spindle bearing 36 having an interior cavity 71 with a complementary shape (see FIGS. 17 and 18) and retain the spindle bearing seated on the spindle without rotational movement of the spindle bearing with respect to the spindle (that is, allowing the spindle and spindle bearing to rotate together).

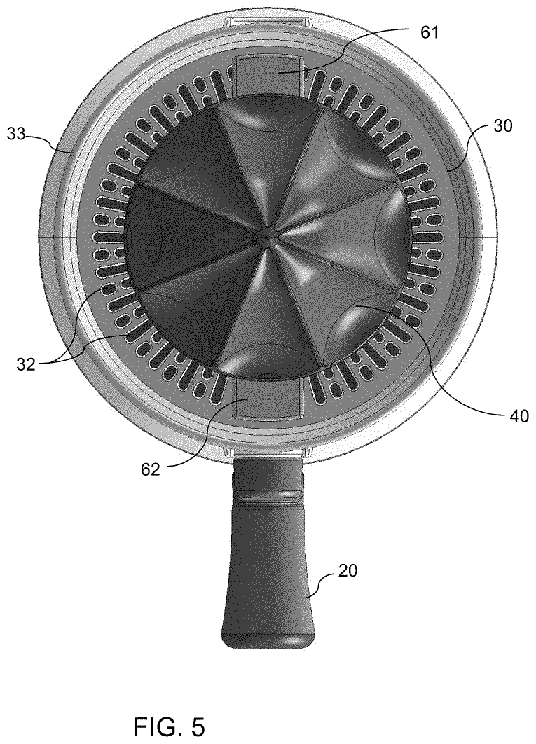

FIG. 5 shows a top plan view of the preferred juicer, with the reamer seated atop the spindle (and spindle bearing) and strainer. In this view, a pair of sweeper arms 61, 62 are also visible, extending radially outward from the center of the strainer toward the sidewall 33 of the strainer, and preferably overlapping the through-holes. Most preferably, each sweeper arm extends radially outwardly to a distance which is radially beyond all of the through-holes.

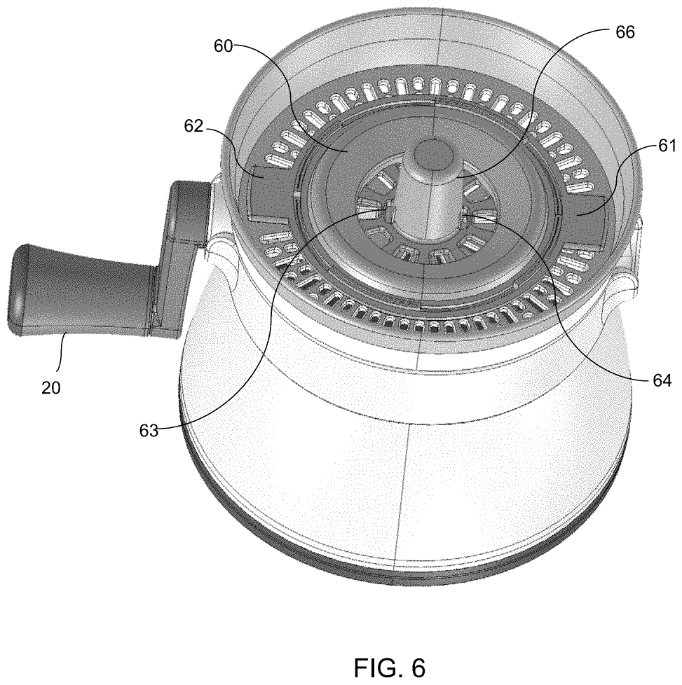

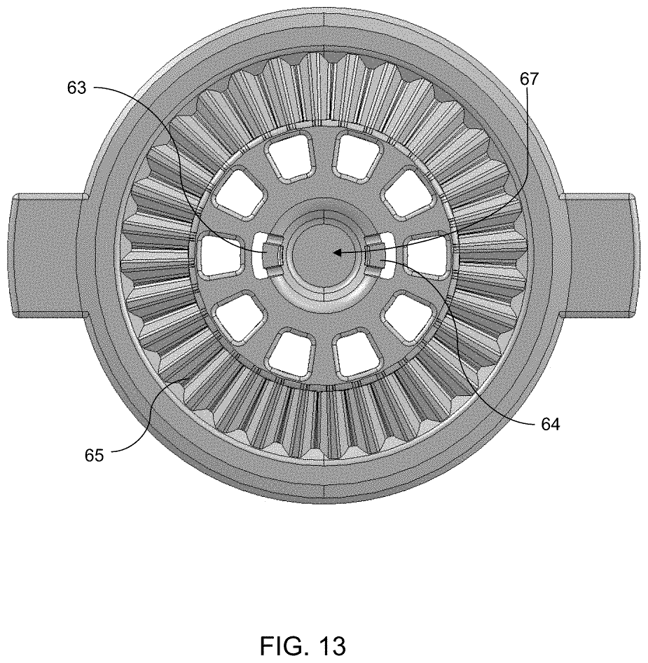

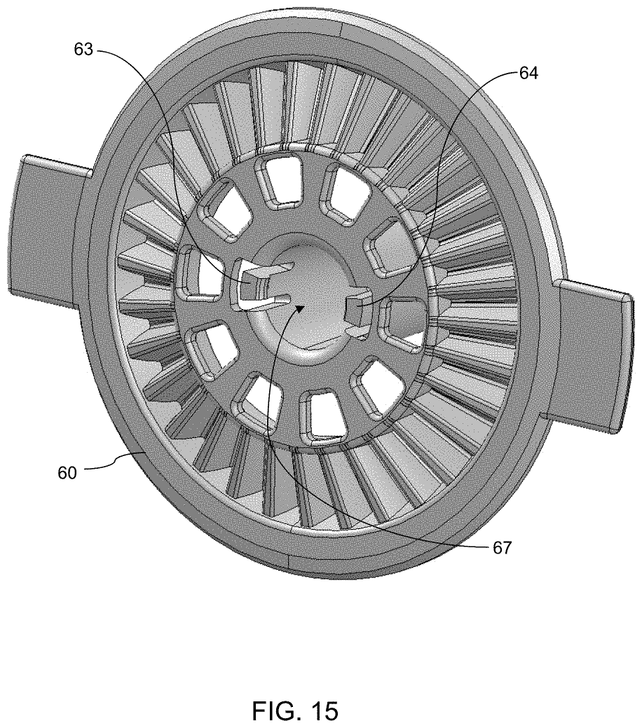

The reamer has been removed in FIG. 6, showing a top perspective view of the juicer without the reamer, and an unobstructed view of the reamer base, configured as a sweeper 60 with its sweeper arms 61, 62. In some versions, the reamer base need not include sweeper arms. The reamer base, or sweeper, further includes a central pillar 66 having an interior cavity 67 (see FIG. 13) sized and arranged so that the central pillar can receive the spindle bearing 36, allowing the central pillar, and therefore the sweeper, to seat atop and rotate around the spindle. The sweeper includes a pair of rocker arms 63, 64 (see also FIG. 15) centrally located on either side of the central pillar 66, arranged to snap-fit around the spindle bearing 36 and retain the central pillar 66 against the spindle bearing, and therefore also retaining the sweeper together with the spindle bearing. Most preferably, the interior of the central pillar 66 is somewhat larger than the outer surface of the spindle bearing so that the central pillar may rotate slidably atop the spindle bearing. As shown in FIG. 6, the sweeper arms extend radially outward toward the sidewalls of the strainer, but are shorter and do not reach the sidewalls.

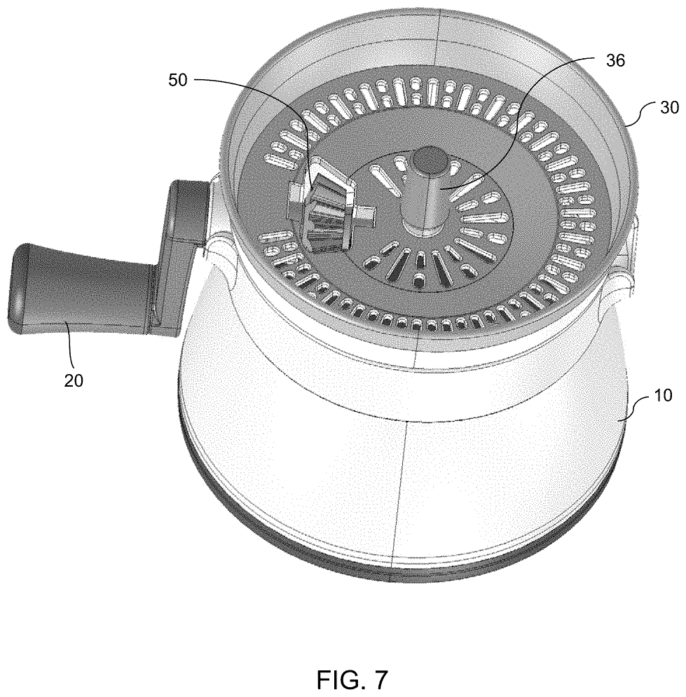

The sweeper has been removed from the same view in FIG. 7, showing the drive gear 50 as in FIG. 4, but in this case including the spindle bearing 36 which was not shown in FIG. 4.

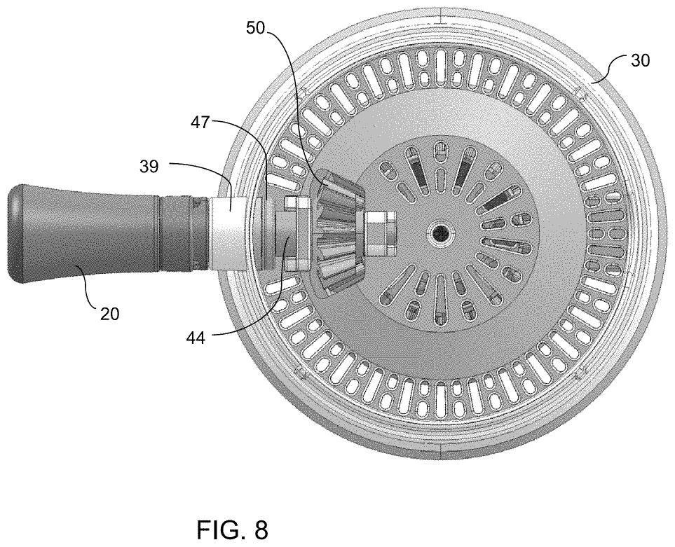

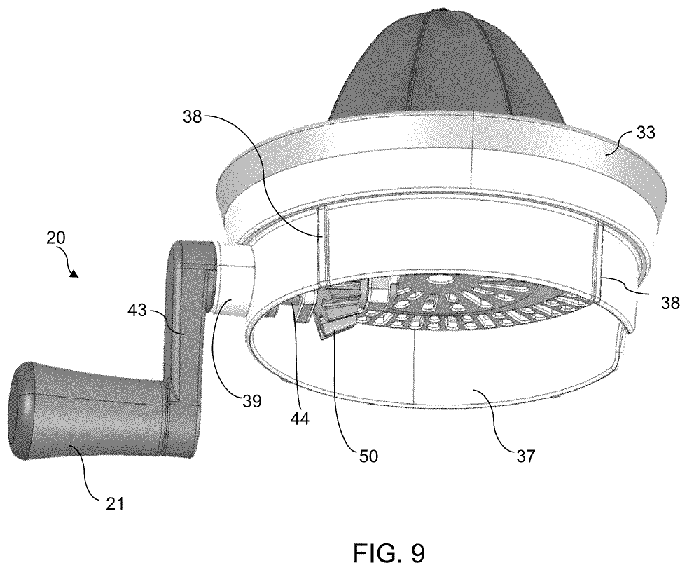

FIG. 8 is a bottom plan view of the juicer without the container, and therefore showing the crank 20, strainer 30, and gear 50. A bottom perspective view of these same components is shown in FIG. 9. In FIG. 9, the lower skirt 37 of the strainer is visible, with a plurality of ribs 38 positioned about the outer perimeter of the skirt. The ribs are formed from an elastomeric material in one version of the invention, and provide a frictional retention aid for the skirt (and therefore the strainer) within the container. As shown, the lower skirt extends downward in a direction opposite the direction of the upper sidewall 33. The lower skirt further includes a crank bearing 39, preferably formed as a cylindrical sleeve which extends radially outwardly for receiving the crank axle which connects to the drive gear. A crank handle 21 is pivotally attached to a crank arm 43, which is coupled to the crank axle 44 to rotate the crank, and thus the gear 50. A retainer clip 47 is fitted within a groove on the crank axle to prevent the crank axle from sliding radially outward of the crank bearing 39.

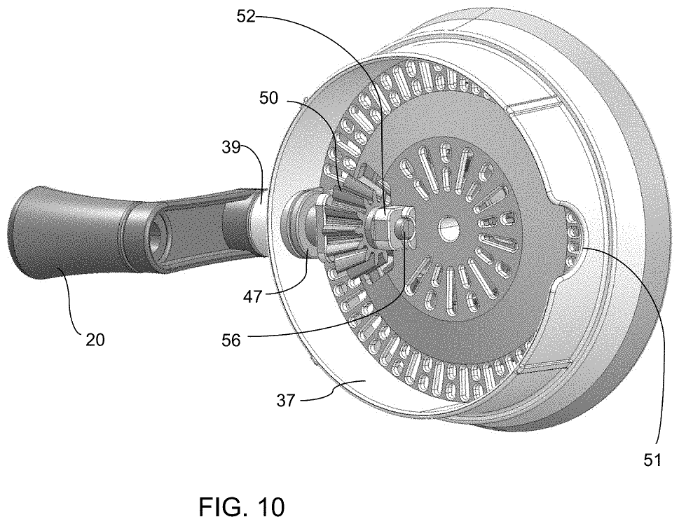

The same substructure of FIGS. 8 and 9 is shown in FIG. 10. In this view, a spout channel 51 is provided within the lower skirt at a position diametrically opposite the crank bearing 39. The spout channel provides a passageway at the location of a spout in the container when the strainer is positioned atop the container, so that juice can be poured from the container without removing the strainer. The lower side of the strainer further includes a boss 52 having a bore for receiving a terminal end 56 of the crank axle, to support the crank axle and retain the gear in the desired location within the opening defined in the strainer.

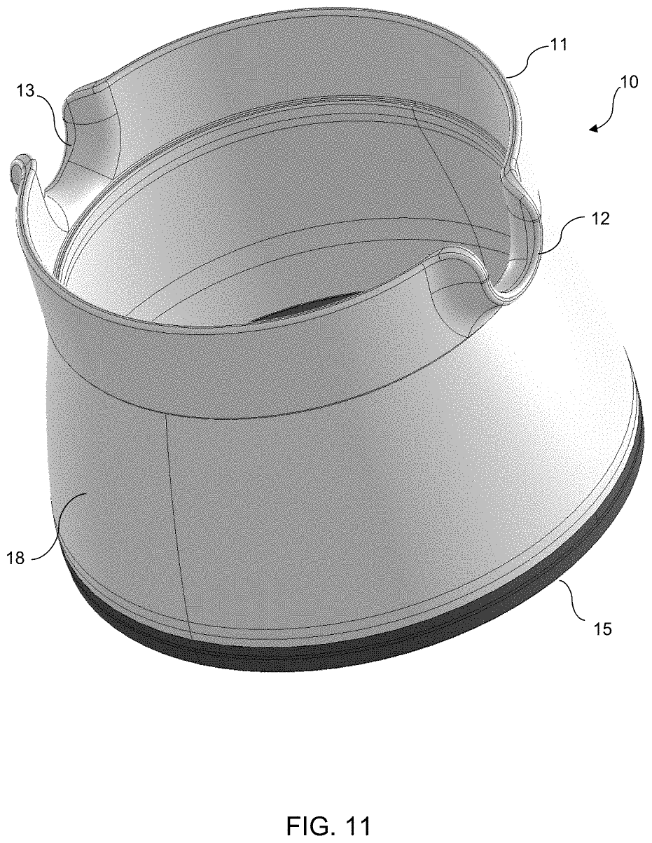

FIG. 11 illustrates the container, separated from the other structures. The container includes a bottom with an upwardly extending sidewall terminating in an upper rim 11, the bottom and sidewalls cooperating to define an interior space. In this view, a pair of diametrically opposing spouts 12, 13 are shown, formed as depressions at the upper rim 11 of the container. In each case, the spouts are formed such that they extend radially outwardly from the container for a distance D (see FIG. 1), forming a shelf which extends outwardly and beyond the rim 11 to receive and support the crank bearing of the strainer. As described above, the strainer has a single crank bearing, with an opposing spout channel. Thus, when the strainer is seated on the container the crank bearing will be seated in one of the two spouts with the spout channel positioned coaxially with the outer spout. By positioning a pair of spouts in diametrically opposite positions, each structurally the same, the strainer may be oriented with the crank bearing seated in either spout. In other versions, only a single spout may be provided. The outer surface of the bottom 15 of the container may include a non-skid material to aid in maintaining the container in a stable position on a countertop when in use.

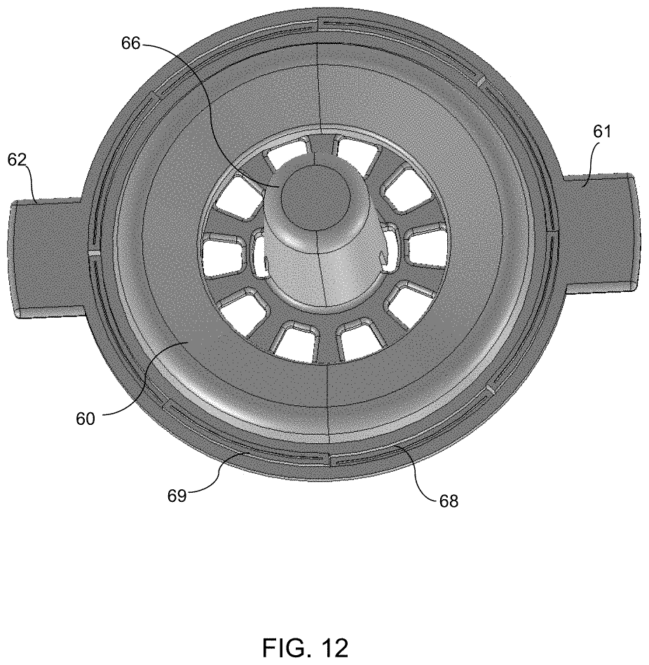

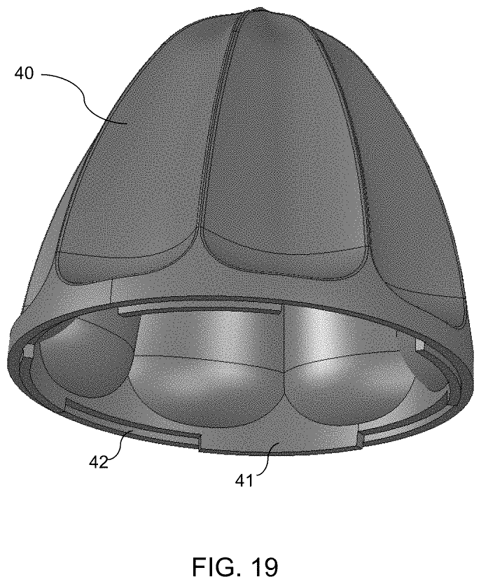

FIG. 12 shows a top perspective view of a preferred sweeper 60. The perimeter of the sweeper is formed with alternating slots 68 and tabs 69, preferably arranged as arcs that combine to define a circle near the perimeter of the sweeper, slightly to the interior of the perimeter. The sweeper tabs and slots are sized and arranged to receive correspondingly sized and arranged tabs 41 and slots 42 positioned at the bottom of the reamer (see FIG. 19). In this fashion, the reamer is preferably trained to the sweeper for movement with the reamer together with the sweeper in a circular fashion about the central axis, but may be removed from the sweeper by lifting it vertically along the central axis.

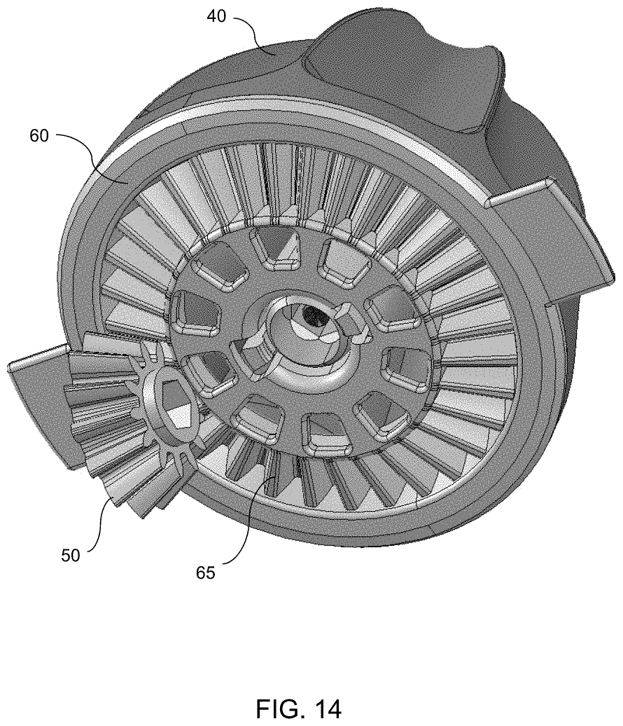

A bottom plan view of the sweeper is shown in FIG. 13, and in perspective view in FIG. 15. A ring gear 65 is formed toward the radially outer portion of the circular sweeper, arranged to interact with the drive gear so that rotation of the drive gear will cause rotation of the sweeper, and therefore the sweeper arms and the attached reamer. In the preferred version as illustrated, the drive gear is beveled and the ring gear is formed with a complementary configuration to engage the beveled drive gear. The interaction of the drive gear 50 and ring gear 65 are further visible in the bottom perspective view of FIG. 14, showing the drive gear 50, ring gear 65, sweeper 60, and reamer 40 with the other components removed. As illustrated, the sweeper arms extend radially outward from the perimeter of the reamer.

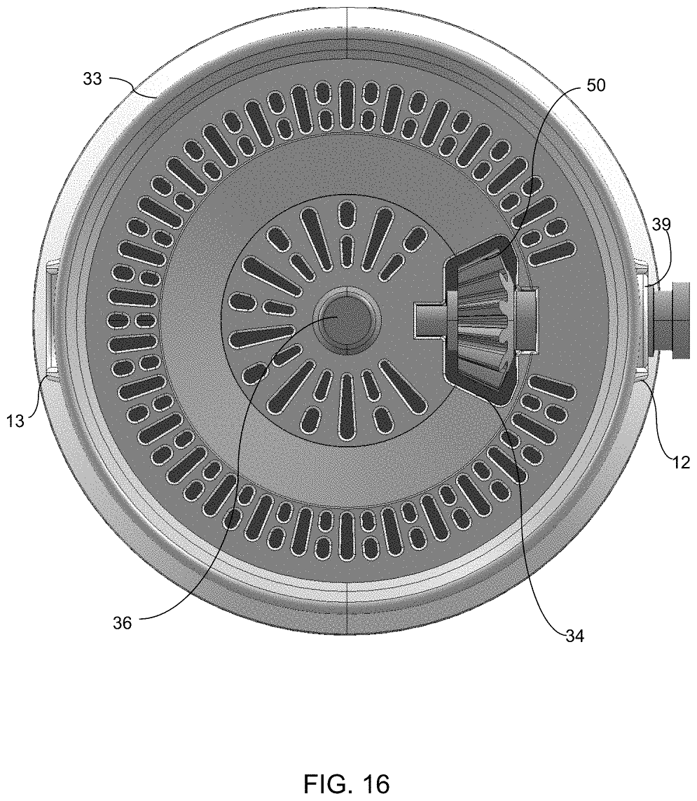

FIG. 16 shows a top plan view of the juicer, with the reamer and sweeper removed, thereby illustrating the drive gear extending through the opening in the strainer, and showing the spindle bearing positioned at the center. The spouts 12, 13 on either side of the container extend radially outward and beyond the rim of the strainer. Likewise, the crank bearing 39 (with the crank arm and handle removed for simplicity of illustration) is shown seated in the spout 12 and radially outward and beyond the rim of the strainer.

In use, the juicer is arranged such as illustrated in FIG. 2, with the reamer, sweeper, and strainer assembled and positioned atop the container. A half of a citrus fruit such as an orange is pressed onto the reamer while the crank handle is rotated. The rotation of the crank handle causes corresponding rotation of the drive gear and therefore the ring gear. In turn, the rotation of the ring gear causes rotation of the sweeper and the reamer with respect to the strainer and the lower container. The rotation of the reamer with respect to the citrus fruit causes the reamer to be inserted into the citrus fruit, expressing the juice. The sweeper arms also rotate with the sweeper, and because the sweeper arms are positioned slightly above and closely adjacent to the strainer, rotation of the sweeper arms will cause them to encounter any pulp positioned atop the strainer, moving pulp out of the way and preventing juice from being blocked by the collected pulp. Once the fruit has been fully pressed, the juice can be poured from the container.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims.

I claim:

1. A juicer, comprising:
a container having a bottom and an upwardly extending sidewall terminating in a rim at an upper end of the container to define an interior space;
a first spout formed on the rim and a second spout formed on the rim;
a strainer removably attached to the upper end of the container, the strainer having a plurality of through-holes and a spindle defining a central axis of the strainer, the strainer further having a crank bearing;
a crank including a crank axle, the crank axle being retained within the crank bearing and terminating in a drive gear, the drive gear being coupled to the reamer for rotation of the reamer via rotation of the crank axle;
the strainer further being selectively positionable in either a first position in which the crank bearing is seated in the first spout, or a second position in which the crank bearing is seated in the second spout.

2. The juicer of claim 1, wherein the reamer is further coupled to a ring gear, the ring gear engaging the drive gear to rotate the reamer.

3. The juicer of claim 2, further comprising a sweeper supported by the spindle, the sweeper having one or more sweep arms extending radially outwardly from the spindle, the spindle coupled to and supporting the reamer, and further wherein the ring gear is formed on a surface of the sweeper, whereby rotation of the drive gear causes rotation of the sweeper and the reamer.

4. The juicer of claim 3, further comprising a spindle bearing attached to the spindle, the sweeper having a central pillar with an internal cavity which receives the spindle bearing for rotation of the central pillar about the spindle bearing.

5. The juicer of claim 3, wherein the first spout and the second spout are diametrically opposite each other.

6. The juicer of claim 1, wherein the first spout and the second spout are diametrically opposite each other.

7. The juicer of claim 5, wherein the strainer further comprises a boss, the boss retaining a portion of the crank axle.

8. The juicer of claim 3, wherein the strainer further comprises a lower skirt, the slower skirt extending below the upper rim when the strainer is positioned at the upper end of the container.

9. The container of claim 8, wherein the lower skirt further comprises one or more ribs on an outer surface of the skirt.

10. The juicer of claim 8, wherein the strainer further comprises an upper strainer sidewall.

11. A juicer, comprising:
a container having a bottom and an upwardly extending sidewall terminating in a rim at an upper end of the container to define an interior space;
a first spout formed on the rim and a second spout formed on the rim;
a strainer having an upwardly extending strainer sidewall and one or more through-holes, the strainer further having a crank bearing, the strainer being selectively supportable by the container in either a first position in which the crank bearing is seated in the first spout, or a second position in which the crank bearing is seated in the second spout;
a reamer supported by the strainer for rotation atop the strainer;
a crank including a crank axle, the crank axle being retained within the crank bearing and terminating in a drive gear, the drive gear being coupled to the reamer for rotation of the reamer via rotation of the crank axle.

12. The juicer of claim 11, wherein the reamer is further coupled to a ring gear, the ring gear engaging the drive gear to rotate the reamer.

13. The juicer of claim 12, further comprising a reamer base supported by the strainer, the reamer base coupled to and supporting the reamer, and further wherein the ring gear is formed on a surface of the reamer base, whereby rotation of the drive gear causes rotation of the reamer base and the reamer.

14. The juicer of claim 13, further comprising a spindle poisoned on the strainer and a spindle bearing attached to the spindle, the reamer base having a central pillar with an internal cavity which receives the spindle bearing for rotation of the central pillar about the spindle bearing.

15. The juicer of claim 14, wherein the first spout and the second spout are diametrically opposite each other.

16. The juicer of claim 11, wherein the first spout and the second spout are diametrically opposite each other.

17. The juicer of claim 16, wherein the strainer further comprises a boss, the boss retaining a portion of the crank axle.

18. The juicer of claim 16, wherein the strainer further comprises a lower skirt, the slower skirt extending below the upper rim when the strainer is positioned at the upper end of the container.

19. The container of claim 17, wherein the lower skirt further comprises one or more ribs on an outer surface of the skirt.

20. The juicer of claim 13, wherein the reamer base is configured as a sweeper having one or more radially extending sweeper arms.
